(19) United States
(12) Patent Application Publication
(10) Pub. No.: US 2001/0053644 A1
(43) Pub. Date: Dec. 20, 2001

(54) Aromatic label and method for making an aromatic label

(75) Inventor: Neil A. Doniger, Dover, NH (US)

Correspondence Address: IP Administrator, Gunster, Yoakley & Stewart, Suite 1400, 500 East Broward Blvd., Ft.Lauderdale, FL, 33394, US

(73) Assignee: Nadco Inc.

(21) Appl. No.: 09/879,362

(22) Filed: Jun. 12, 2001

Related U.S. Application Data
(60) Provisional application No. 60/211,998, filed on Jun. 16, 2000.

(51) Int. Cl. B32B 3/00; B32B 5/02; B32B 9/00; B32B 27/04; B32B 27/12

(52) U.S. Cl. 442/59; 442/149

(57) ABSTRACT

An aromatic label and method for making an aromatic label are provided. An aromatic chemical is applied to a substrate using a printing process. The aromatic chemical is dried using a dryer. The substrate having the dried aromatic chemical applied thereto is packaged in a sealed, substantially airtight package. The aromatic chemical can be citronella and can be applied using a flexographic printing process.

### CROSS-REFERENCE TO RELATED APPLICATION

This application is related to and claims priority to U.S. Provisional Patent Application Ser. No. 60/211,998, filed Jun. 16, 2000, entitled METHOD FOR PRINTING AN AROMATIC CHEMICAL ONTO A SUBSTRATE, the entirety of which is incorporated herein by reference.

### STATEMENT REGARDING FEDERALLY SPONSORED RESEARCH OR DEVELOPMENT

n/a

### FIELD OF THE INVENTION

The present invention provides an aromatic label and method for printing an aromatic chemical, such as a bug repellant, onto a substrate, and in particular, to a method which preferably employs one of flexographic printing, screen printing, offset lithography or gravure printing to coat a substrate such as an adhesive substrate with the aromatic chemical in conjunction with a traditional ink-based graphic.

### BACKGROUND OF THE INVENTION

The proliferation of insect borne diseases such as the West Nile virus has stimulated the need for ways to deploy insect repellants in ways which are cost effective to manufacture and purchase as well as provide convenience to the user. In addition, the desire to provide a convenient means for the deployment of other aromatic chemicals such as fragrances, perfumes and the like enjoys significant demand.

Devices for the deployment of these aromatic chemicals are known. For example, Canadian Patent Application No. 2,147,595 (the '595 Application) describes a patch which is adapted to repel insects in which the repellant does not contact the wearer's skin. The patch described in the '595 Application is a pressure sensitive adhesive which comprises an outer layer of absorbent material which has been impregnated with an insect repellant. Impregnating the absorbent material is time consuming and requires the use of a substantial amount of bug repellant.

In addition, the use of an absorbent material such as cloth is problematic in the case where an additional graphic such as a logo, advertisement or design, etc., is visibly placed on the outer surface of the patch. This is the case because a printed coating on the cloth may obviate the ability of the cloth to absorb the repellant and because the textured nature of the absorbent material may not be conducive to the imprintation of a graphic.

The use of citrinella oil was found by the '595 application to destroy the efficacy of the adhesive. As a solution, the '595 application proposes dispensing the repellant in a separate sealed pouch, thereby requiring the user to open the repellant pouch and pour the contents onto the absorbent pad. This method potentially results in the user coming into contact with the aromatic chemical, e.g., bug repellant.

It is desirable to provide an aromatic label and a method by which an aromatic chemical such as a bug repellant, fragrance or perfume can be economically placed on a substrate, particularly an adhesive substrate, in a manner which does not deteriorate the efficacy of the adhesive and in which the user need not come into contact with the aromatic chemical itself.

### SUMMARY OF THE INVENTION

An aromatic label and method for making the same is provided which is efficiently manufacturable and arranged such that the user need not come into contact with the aromatic chemical, either by having to touch the chemical or by having the chemical bleed through the substrate and coming into contact with the user's clothing or person. The label is advantageously arranged so as to accommodate a graphic printed thereon.

According to an aspect, the present invention provides a method for making an aromatic label. An aromatic chemical is applied to a substrate using a printing process. The applied aromatic chemical is dried using a dryer. The substrate having the dried aromatic chemical applied thereto is packaged in a sealed, substantially airtight package.

According to another aspect, the present invention provides a method for using a flexographic printing process to produce an aromatic label. Citronella oil is applied to an adhesive substrate using the flexographic printing process. The citronella oil is dried using a dryer. The adhesive substrate is die cut into one or more labels. The labels having the dried citronella oil applied thereto are packaged in a sealed, substantially airtight package.

According to still another aspect, the present invention provides an aromatic label in which a flexographically printable adhesive substrate has an adhesive side and a substantially impermeable side opposite the adhesive side. An aromatic chemical, applied to the substantially impermeable side, has a lay-down thickness of 0.001 to 0.002 inches.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is an example of a label having a graphic and aromatic chemical printed thereon in accordance with the principles of the present invention;

FIG. 2 is a section view of the drawing shown in FIG. 1 taken through section 2-2; and

FIG. 3 is a flow chart showing the process used to prepare the label shown in FIGS. 1 and 2.

### DETAILED DESCRIPTION OF THE INVENTION

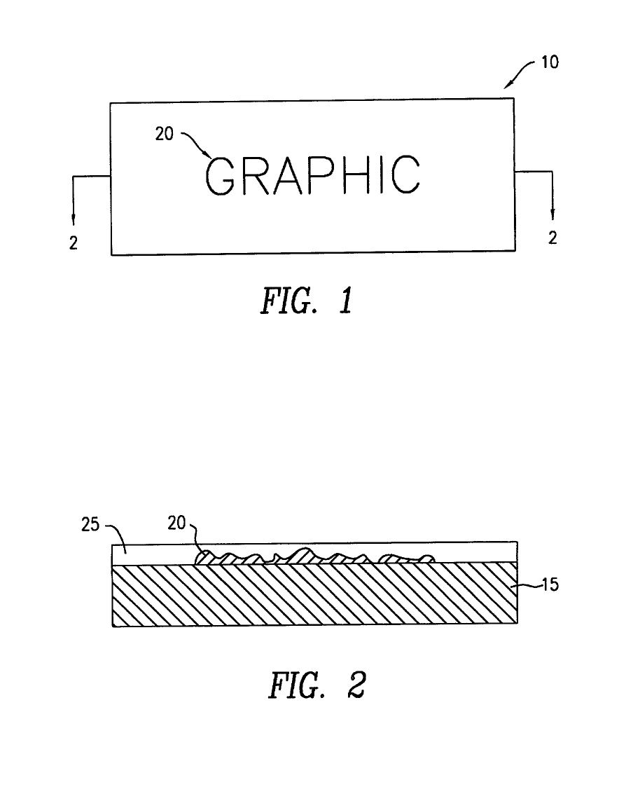

Referring now to the drawing figures in which like reference numerals refer to like elements, there is shown in FIG. 1 a label 10 constructed in accordance with the principles of the present invention. Label 10 is preferably comprised of a substrate 15 upon which an optional graphic 20 has been printed. Aromatic chemical layer 25 is printed on one or more of adhesive substrate 15 and graphic 20.

Substrate 15 can be any known product upon which a graphic can be printed, for example, polyester, vinyl, paper, polyethylene and the like, and is preferably an adhesive-backed substrate. Use of an adhesive substrate allows the resultant label to be removably attached to the user. In the case where the label will be adhered directly to the user's skin, a hypoallergenic adhesive made for direct skin contact is preferably used. When using an adhesive substrate, the adhesive substrate has an adhesive side and a substantially impermeable side opposite the adhesive side. Graphic 20 is preferably printed using a solvent-based ink.

Aromatic chemical layer 25 can be any aromatic chemical but is preferably a fragrance, perfume, citronella oil or N, Ndiethyl-mtoluamie (DEET). Citronella oil and DEET are employed for their bug repelling properties. In the case where DEET is used as aromatic chemical layer 25, substrate 15 is preferably a polyester in order to avoid the DEET chemical dissolving substrate 15.

Graphic 20 and aromatic chemical layer 25 can be printed onto substrate 15 using a printing process such as screen printing, lithography or gravure, but are preferably printed using a flexographic printing process. The printing press material throughput speed is preferably set at substantially 100 feet/minute to substantially 200 feet/minute. Although graphic 20 and aromatic chemical layer 25 are preferably printed separately, it is contemplated that a traditional ink used to print the graphic can be mixed with certain of the aromatic chemicals such as fragrances and printed as a single color, preferably by flexographic printing.

Flexographic printing is preferred because screen printing is too time consuming and therefore not cost effective. Lithography is not practical due to the heavy viscosity of typical aromatic chemicals such as citronella oil. Gravure printing is too costly.

Using a flexographic printing process, the preferred thickness of aromatic chemical layer 25 for citronella oil, i.e. lay-down thickness, is substantially 0.001 inches to substantially 0.002 inches. In order to achieve this lay-down thickness range, a 250 line anilox roller without a doctor blade is used. This lay-down thickness provides an odor using citronella oil which is not over-powering to the user.

Using traditional flexographic printing processes, each printing station employs a dryer to dry the applied graphic ink and/or aromatic chemical layer 25. The dryer in the print station which prints aromatic chemical layer 25 is preferably an infrared dryer adapted to provide a higher drying temperature than that normally used to dry traditional inks. It has been found that the higher drying temperature advantageously facilitates packaging while maintaining the aromatic nature of the applied chemical by allowing the label to be quickly packaged avoiding unnecessary dispersion of the aromatic chemical. For example, a drying temperature of approximately 180 degrees Fahrenheit provides acceptable drying results, especially when operating the printing press material throughput speed at the above-described approximately 200 feet/minute. It is further contemplated that labels 10 can be formed by die cutting substrate 15 preferably upon completion of the printing processes.

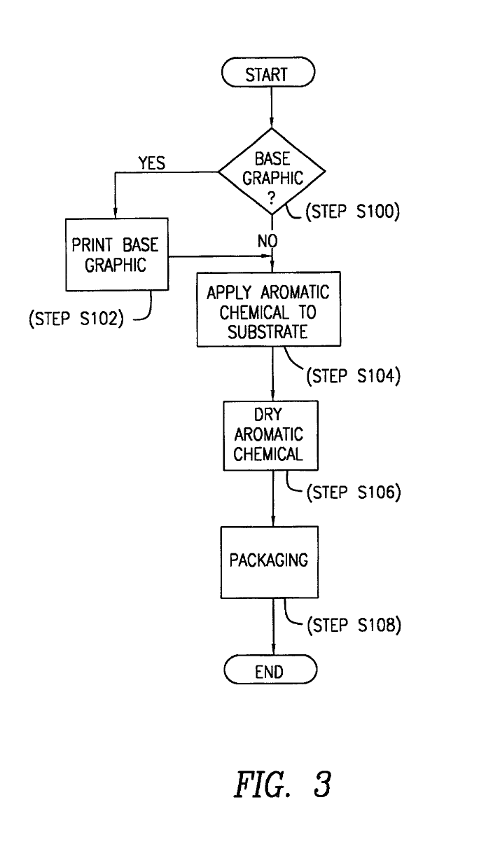

FIG. 3 is a flow chart of the method of making label 10 according to the present invention. In the case where a base graphic 20 is being printed on substrate 15 (step S100), the base graphic is printed using one of the above-described printing processes, preferably flexographic printing (step S102). It is contemplated that step S102 can comprise multiple colors printed on substrate 15 by one or more printing stations, particularly when a flexographic printing process is employed.

Once the optional base graphic 20 is applied to substrate 15, aromatic chemical layer 25 is applied to the adhesive substrate and graphic 20 (step S104). The aromatic chemical is dried using known drying equipment such as those employed within traditional flexographic printing presses (step S106), and the manufactured label 10 packaged.

Labels 10 can be packaged individually or in any other suitable form such as rolls, sheets, etc., it being preferred, however, that the manufactured labels be packaged such that they are sealed, for example in a barrier bag or other protective sealing package. Sealing labels 10 prevents aromatic chemical layer 25 from depleting, thereby maintaining the aromatic nature of the applied layer.

The present invention advantageously provides a simple method which employs known printing techniques to print an aromatic chemical onto substrate such as an adhesive backed substrate along with an optional graphic and/or die cutting step. The method of the present invention provides a cost effective way to apply an aromatic chemical such as a perfume, fragrance, citronella oil or DEET to the substrate. The substrate can then be advantageously affixed to the user's clothing, bag, skin, etc., in a manner which obviates the need for the user to directly apply the fragrance to their skin or article of clothing.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method for making an aromatic label, comprising:
applying an aromatic chemical to a substrate using a printing process;
drying the applied aromatic chemical using a dryer; and
packaging the substrate having the dried aromatic chemical applied thereto in a sealed, substantially airtight package.

2. The method of claim 1, wherein the substrate is an adhesive substrate.

3. The method of claim 2, further comprising applying a base graphic onto the adhesive substrate using the printing process.

4. The method of claim 3, wherein the base graphic is applied to the adhesive substrate prior to applying the aromatic chemical to the substrate.

5. The method of claim 3, wherein the base graphic comprises more than one color.

6. The method of claim 2, wherein the printing process is a flexographic printing process.

7. The method of claim 3, wherein the printing process is a flexographic printing process.

8. The method of claim 2, further comprising die cutting the adhesive substrate to form one or more labels.

9. The method of claim 2, wherein the aromatic chemical is citronella oil.

10. The method of claim 2, wherein the aromatic chemical is DEET.

11. The method of claim 2, wherein the adhesive substrate is comprised of polyester.

12. The method of claim 2, further comprising setting a printing press material throughput speed of substantially 100 feet/minute to substantially 200 feet/minute.

13. The method of claim 12, wherein the drying is performed using a drying temperature of approximately 180 degrees Fahrenheit.

14. The method of claim 9, where the citronella oil is applied at a lay-down thickness of substantially 0.001 to substantially 0.002 inches.

15. A method for using a flexographic printing process to produce an aromatic label, comprising:
applying citronella oil to an adhesive substrate using the flexographic printing process;
drying the citronella oil using a dryer;
die-cutting the adhesive substrate into one or more labels; and
packaging the labels having the dried citronella oil applied thereto in a sealed, substantially airtight package.

16. The method according to claim 15, wherein the citronella oil is applied at a lay-down thickness of substantially 0.001 to substantially 0.002 inches.

17. The method according to claim 16, wherein the drying is performed using a drying temperature of approximately 180 degrees Fahrenheit.

18. The method according to claim 17, further comprising setting a printing press material throughput speed of substantially 100 feet/minute to substantially 200 feet/minute.

19. The method according to claim 15, further comprising applying a base graphic onto the adhesive substrate using the flexographic printing process.

20. An aromatic label, comprising:
a flexographically printable adhesive substrate, the adhesive substrate having an adhesive side and a substantially impermeable side opposite the adhesive side;
an aromatic chemical applied to the substantially impermeable side, the aromatic chemical having a lay-down thickness of 0.001 to 0.002 inches.

21. The aromatic label of claim 20, wherein the aromatic chemical is citronella oil.

22. The aromatic label of claim 20, wherein the aromatic chemical is DEET.
